(19) United States
(12) Patent Application Publication
(10) Pub. No.: US 2002/0122237 A1
(43) Pub. Date: Sep. 5, 2002

(54) Method and apparatus for spatial light modulation

(76) Inventors: Torbjorn Sandstrom, Pixbo (SE); Ulric Ljungblad, Molndal (SE); Peter Durr, Dresden (DE)

Correspondence Address: HAYNES BEFFEL & WOLFELD LLP, P O BOX 366, HALF MOON BAY, CA, 94019, US

(21) Appl. No.: 09/797,429

(22) Filed: Mar. 1, 2001

(51) Int. Cl. G02B 26/00

(52) U.S. Cl. 359/291; 359/290; 359/292; 359/293

(57) ABSTRACT

The present invention includes a method to use a phase modulating micromirror array to create an intensity only image that has high image fidelity, good stability through focus and good x-y symmetry. The method uses pixels consisting of at least one tilting mirror element and adjacent pixels tilt in different ways, but they are laid-out in a pattern that creates effective averaging between pixels with different tilt. The pattern is such that even if a single pixel creates a reflecting or scattering pattern that is asymmetric relative to the specular direction every neighborhood consists of pixels that together create symmetry. The invention allows the use of single-mirror pixels instead of multi-element pixels, thereby making manufacturing and design easier and also makes a smaller pixel size possible. Particular aspects of the present invention are described in the claims, specification and drawings.

### FIELD OF THE INVENTION

This invention relates to micromirror spatial light modulators SLMs used for producing high-precision images, such as but not limited to pattern generators for microlithography. Other forms of optical printing in broad sense, such as computer-to-plate printing, security printing, photoablation, materials processing may also make use of the invention, as will TV and computer displays. Other possible uses is in optical computing, adaptive optics and in optical cross-switches based on Micromirror SLMs.

### BACKGROUND OF THE INVENTION

Micromirror spatial light modulators can be used make projection displays and pattern generators. These SLMs may be based on matrix-addressed arrays of micromechanical mirrors that are actuated by electrostatic force, such as arrays made by Texas Instruments DMD and the Fraunhofer Institute of Microelectronic Circuits and Systems FhG-IMS, or by piezoelectric actuators, such as made by Daewoo. Patent applications and published material by the current inventors further illustrate use of SLMs.

FIG. 1 shows in simplified form a micromirror array from FhG-IMS. A grid of pixels, five rows by six columns, is illustrated. Cell or pixel 101 includes corner posts 102. An X-pattern 103 divides this pixel into four mirror elements. A single electrostatic actuator deflects all four mirror elements.

FIGS. 2 and 3 shows a single cell 101 of the FhG-IMS array in top and cross section views, respectively. The cross section FIG. 3 shows how the mirror is deflected by the force of the electric field between the mirror elements 301 and the electrode 302 and counter electrodes 303 embedded in the surface under the mirror.

FIG. 1 also shows a mirror array where some elements are addressed (e.g., 110) and some are not (e.g., 101.) The non-addressed elements are flat and the addressed ones are pulled in like an inverted pyramid toward the center of the X-pattern 103. Not shown in the pictures is how the plate bends close to the supporting posts by means of a designed flexure.

### SUMMARY OF THE INVENTION

The present invention includes a method to use a phase modulating micromirror array to create an intensity only image that has high image fidelity, good stability through focus and good x-y symmetry. The method uses pixels consisting of at least one tilting mirror element and adjacent pixels tilt in different ways, but they are laid-out in a pattern that creates effective averaging between pixels with different tilt. The pattern is such that even if a single pixel creates a reflecting or scattering pattern that is asymmetric relative to the specular direction every neighborhood consists of pixels that together create symmetry. The invention allows the use of single-mirror pixels instead of multi-element pixels, thereby making manufacturing and design easier and also makes a smaller pixel size possible. Particular aspects of the present invention are described in the claims, specification and drawings.

### BRIEF DESCRIPTION OF THE DRAWINGS

FIG. 1 is a block diagram of a system handling documents in accordance with aspects of the present invention.

FIG. 2 is a block diagram of a document including tagged fields.

FIG. 3 illustrates participants in a marketplace.

FIG. 4 depicts assignment of a URI value to a typed variable.

FIG. 5 illustrates a user interface for requesting a view of a document.

FIG. 6 depicts assignment of a URI value to a typed variable.

FIGS. 7 and 8 are an example of a document and a transformation for display.

FIG. 9 is an overview of code used to translate XML to HTML, for the display in FIG. 8.

FIG. 10 is a variation on FIG. 8, depicting the effect of a user collapsing data.

FIG. 11 is a flow chart of HTML to HTML conversion, for the display in FIG. 10.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

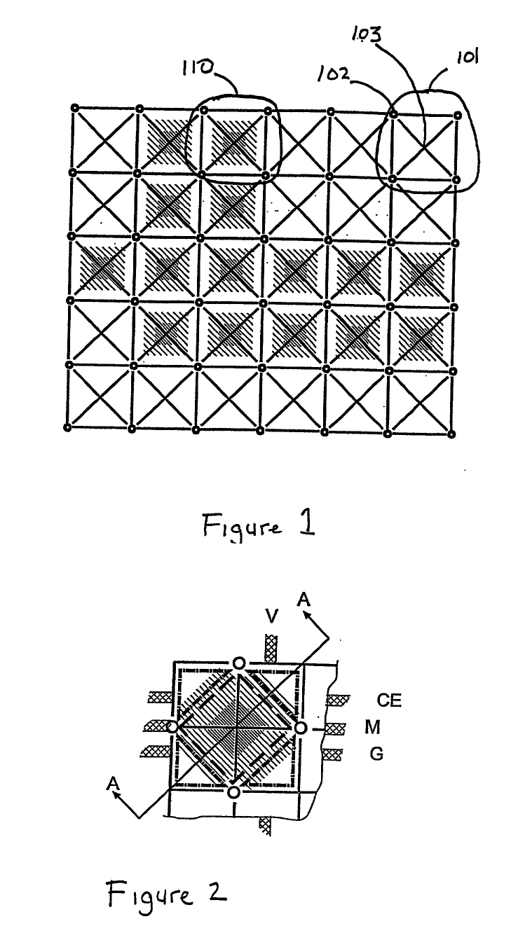

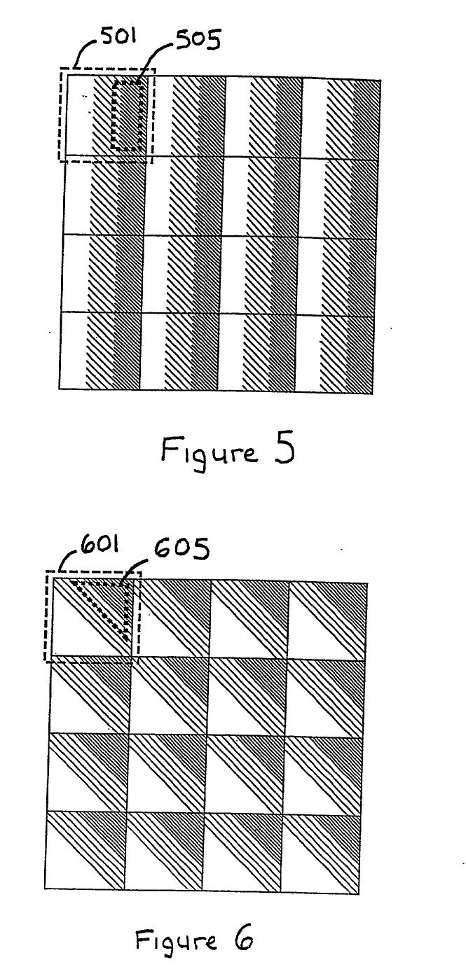

In some applications, mirror elements that tilt or pivot around a central axis may be preferable to mirror elements that bend or are hinged one edge as in FIGS. 1, 2 and 3. Such center-pivoting elements are shown in FIGS. 4, 5, and 6. FIG. 4 shows two mirror layouts with four pivoting elements per addressed. Cell or pixel 401 includes pivot posts 402. An X-pattern 403 divides this pixel into four mirror elements. The elements each are center pivoting along the axes represented by dotted lines 404. A single electrostatic actuator deflects all four mirror elements at the center. Counter electrodes may be positioned in the corners of the cell, across the pivot axes 404 from the center of the X-pattern 403. The imaging properties of this pattern include x-y symmetry and good image stability through a range of focus. FIG. 5 is a micromirror pattern used by Daewoo. FIG. 5 is a pattern used by Texas Instruments.

In FIGS. 5 and 6, all of the mirror elements tilt in the same direction. For instance, in FIG. 5, cell 501, if an electrostatic actuator were used, it would be positioned at 505, causing the mirror to bend or pivot downward. In this figure, all of the mirror elements tilt down to the right. In FIG. 6, cell 601, an electrostatic actuator is positioned at 605, causing the mirror to bend or pivot downward. In this figure, all of the mirror elements tilt down to top right corner of the cell.

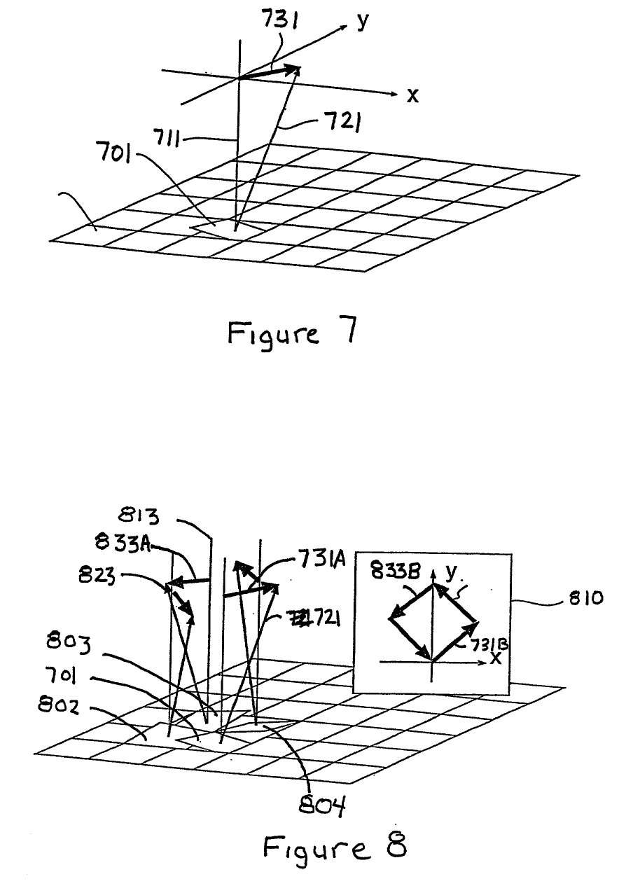

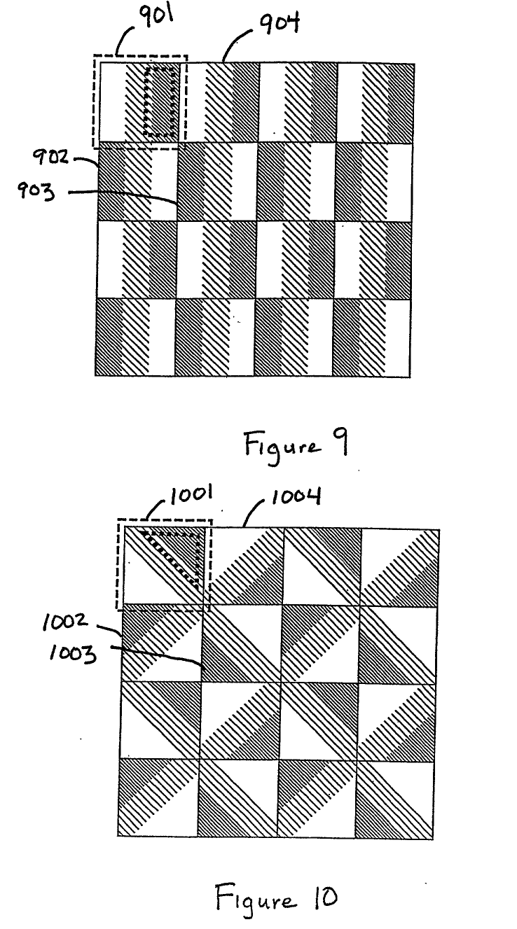

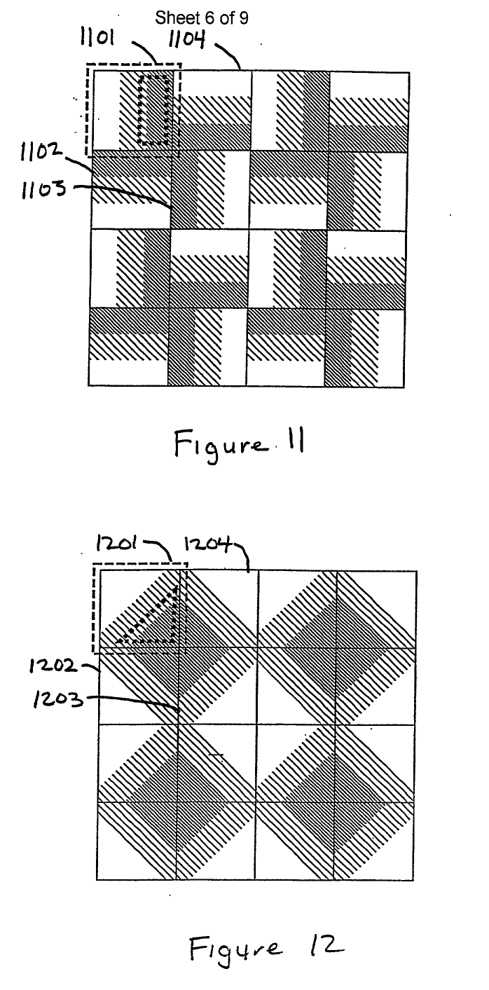

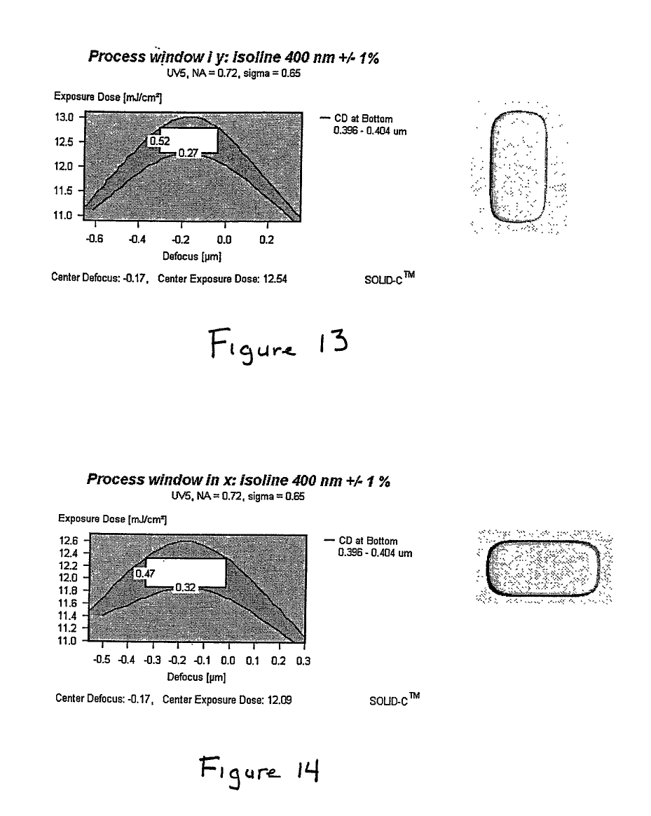

The invention uses a principle of mirror array layout exemplified by FIGS. 7-8. In this example, each separately addressable pixel has a single mirror element 701. The normal 711 is perpendicular to the non-tilted, non-actuated element 701. The unit vector 721 is perpendicular to the tilted, actuated element 701. The direction vector 731 of the unit vector 721 is measured from the normal 711 to the end of the unit vector 721. Defining the length of the unit vector as one, the length of the direction vector is the sine of the angle between the normal 711 and the unit vector 721. The orientation of the direction vector 731 is perpendicular, in the x-y plane, to the tilt axis of the mirror element 701.

In FIG. 8, adjacent mirror elements (701, 802, 803, 804) tilt in two or more different directions. In this figure, the numbering of FIG. 7 has been adopted. Mirror element 803 has a normal 813, a unit vector 823 and a direction vector 833. The inset 810 is tied to the main diagram by the numbering of the director vectors 731 B and 833B, which correspond to 731A and 833B. The inset 810 illustrates that the vector sum of the four direction vectors for the four mirror elements 701, 802, 803 and 804 is essentially zero.

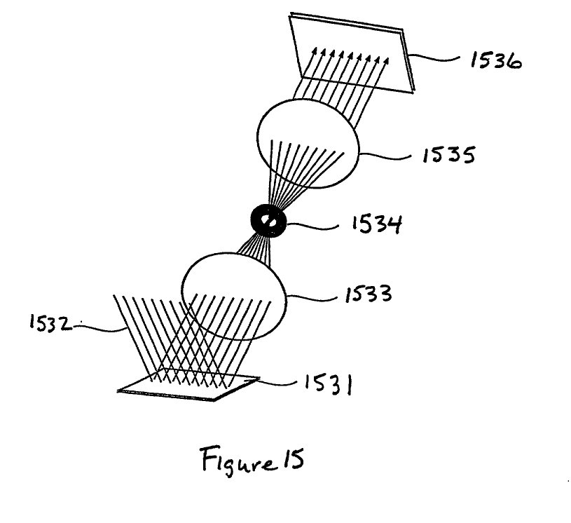

FIG. 9 depicts a first embodiment practicing aspects of the present invention, in which the mirror element array is composed of rows of mirror elements, in which the mirror elements alternating row pivot in opposing directions. The mirror elements in the row including 901 and 904 pivot down to the right, whereas the mirror elements in the alternating row including 902 and 903 pivot down to the left. The direction vectors of mirror elements 901 and 902 sum to essentially zero, when the two elements are actuated. Similarly, direction vectors of mirror elements 901, 902, 903 and 904 sum to essentially zero, when all four elements are actuated. In a strict sense, there is only symmetry in the horizontal direction, but detailed simulations have shown that in actual use the asymmetry is extremely small. In one computer experiment, lines along the horizontal and vertical directions were created with an SLM and projected onto a photoresist using 248 nm radiation and NA 0.72. The line width was 0.4 microns and the line width difference between the directions was only 0.004 microns. Furthermore, it was shown that the process windows of horizontal and vertical lines were closely similar. The SLM according to the first embodiment, thus, provides good symmetry between the axes.

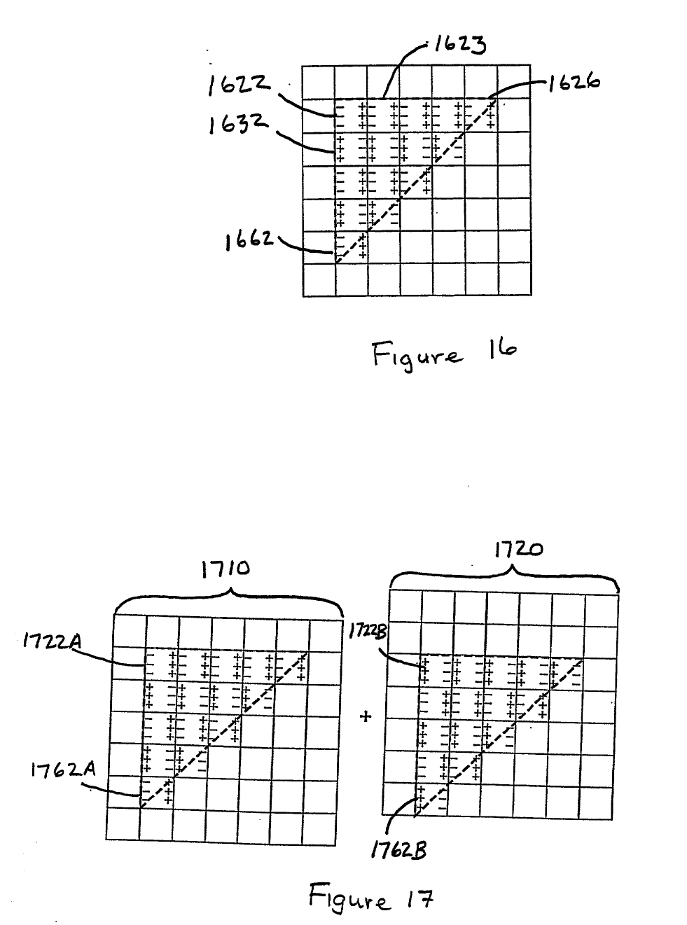

FIG. 10 depicts a second embodiment having mirror elements tilting in four directions, in a regular pattern. The direction vectors of mirror elements 1001, 1002, 1003 and 1004 sum to essentially zero, when all four elements are actuated. This pattern of mirror elements has four-way symmetry. Since there is some averaging in the projection optics due to the finite resolution, edges in all four cardinal directions will have the same properties and lateral displacements or asymmetries through focus are much reduced.

FIGS. 11 and 12 depict third and fourth embodiments. In each of these embodiments, the direction vectors of mirror elements xxx1, xxx2, xxx3 and xxx4 sum to essentially zero, when all four elements are equally actuated.

To evaluate alternative mirror element patterns for a certain application one can simulate the projection properties by means of an image simulation program. The mathematics are well known and can be found in many textbooks on optics and lithography, so that a model can be programmed directly in C or in a mathematical analysis code like MATLAB. The image can conveniently be analyzed in a lithography simulation program, such as the commercially available programs Prolith/3D, from Finle Engineering, Texas, USA, and Solid-C, from Sigma-C, Munich, Germany. More limited analysis is also possible using optical programs such as GLAD and Code-V.

FIGS. 13 and 14 show a Solid-C simulation of resist images of two short lines (0.4×0.8 micron) oriented along x and y. The input to the simulator is 248 nm, NA=0.72 and a micromirror array according to embodiment 1 with 16×16 micron pixels demagnified 160 times. The micromirror has 4×8 and 8×4 pixels set to black, respectively, creating a non-illuminated area in a bright background. The resist is UV5 from Shipley and the dose 12 mJ/sq.cm. The preferred images should look identical, except for the rotation; they should have symmetric corners and no edge roughness. The images corresponding to the two simulations appear to the right of the graphs. Analyzing the results closely, the horizontal line is 0.004 microns wider. This degree of x-y symmetry is acceptable. In an operating pattern generator, this degree of symmetry it can be corrected by a slight adjustment of the feature size in software.

While the preceding examples have been described in binary terms, with mirror elements actuated or not, the current invention also applies to analog light modulation, in which mirror element pivot assumes analog pivot angles. Analog modulation tends to remove phase effects of partially turned-on elements. It is also suitably used in diffractive spatial light modulators, in which the light modulation is controlled more by diffraction than by specular reflection and the phase effects of alternate rows of mirror elements have a larger influence.

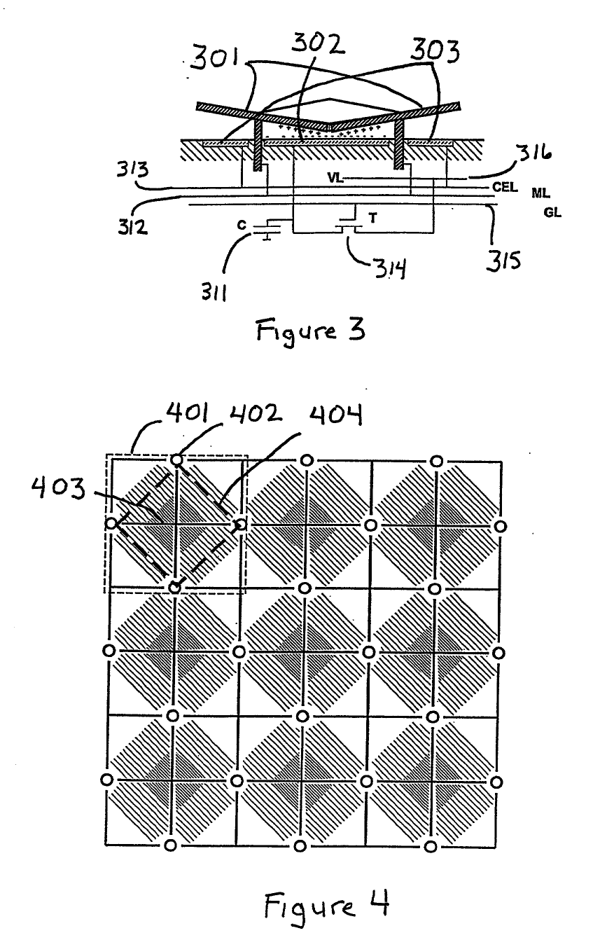

One embodiment of a method practicing aspects of the present invention involves a laser pattern generator for writing line widths below 0.25 microns. FIG. 15 depicts an apparatus which an object plane 1531. A first lens 1533 transforms radiation 1532 reflected from the object plane 1532 into a Fourier plane. The radiation 1532 passes through a Fourier filter 1534. This filter is sized and shaped to average reflected radiation in approximately 2 by 2 mirror element grids. The Fourier filter essentially transmits radiation carrying intensity and not phase effects from the mirrors. A suitable illumination source is an excimer laser with 248 nm wavelength. The NA of the final lens in this embodiment is 0.72. The micromirror array has 2048 by 512 individually addressable mirror elements. Each mirror element pivots on a single, central axis. The mirror array is formed on top of a high-voltage CMOS driving chip that has addressing logic and for each pixel a switch transistor with a storage capacitance. This addressing logic resembles the logic of FIG. 3. Under one side of the mirror 301, there is an electrode 302 connected to a storage capacitor 311. The mirror is connected to an external voltage source 312. Under the opposite side of the mirror 301 is a counter-electrode 303 to provide a known potential, also provided by an external voltage source. The addressing logic scans the rows of the array and opens a transistor 314 by a signal 315 to the gate of the transistor in each cell in synchronicity with analog voltages being applied to column lines 316 connected to the source of the transistors. The circuit is similar to that in a TFT-LCD panel.

The micromirror array has the layout of FIG. 16. Individual mirror elements are numbered. The pivoting action of actuated mirror elements are depicted by “+++” for portions of mirror elements which project out of the figure and “−−−” for portions of mirror elements which project into the figure. Rows of mirror elements pivot with opposing actions. For instance, the right side of element 1622 projects out of the figure while the right side of adjacent element 1632, in the next row, projects into the figure. The resolution of the projection optics is approximately 2 pixels and the phases over a two-by-two pixel are essentially averaged in the image. This represents a trade-off between resolution and residual phase effects. A diagonal line, along mirror elements 1626 through 1662, is formed from mirror elements having opposing pivot actions. Computer simulations indicate that the printing fidelity is predictable and uncomplicated with symmetrical corners, symmetry between x and y lines and stable image size and placement through focus. This is the result of the micromirror pattern layout. Simulations with layouts such as with all mirrors tilting in the same direction give an inferior result.

The micromirror array is illuminated with 1000 flashes from the excimer laser every second. The voltages controlling mirror elements are reloaded between the flashes and a contiguous pattern is stitched together. The pattern is printed in four overlaid passes, where two passes have the same pixel placement by with the micromirror moved so that in the second pass a right-tilting mirror prints where a left-tilting mirror printed in the first pass. FIG. 17 depicts this printing pattern. One pass is depicted by exposure grid 1710 and another pass is depicted by exposure grid 1720. The pattern in these grids falls on the same place on the image plane. The two exposure grids are shifted vertically by one row of mirror elements. Exposure element 1762A prints in the same place on the image plane as exposure element 1762B. Different mirror elements are used to print exposure element 1762A and 1762B. These mirror elements have opposing pivot actions. In this way, residual phase effects are further cancelled. After the first two passes two more passes are printed with the pixel location moved by half a grid unit in x and half a grid unit in y. The four passes also have displaced printing fields so that the stitching boundaries fall in a different places for each pass. In another embodiment, mirror elements could have four different pivot actions, as in FIGS. 10 through 12, and four passes could result in exposure of each exposure element with mirrors having different pivot actions. Displacement by a single row or just half a grid unit is not important to this invention; it can be practiced by any displacement that results in exposure to different mirror pivot actions.

The invention has been described by but is not limited by a number of examples. In particular it is possible to use a hexagonal pixel grid, which in applications to image processing and optical computing may be advantageous. With a hexagonal grid the mirrors may also be hexagonal or they could have a different shape. The invention teaches the use of a layout pattern where the pixels have different tilting properties but average out over every small neighborhood. More specifically the pattern can be made from repeating triads of three adjacent pixels. Another variation is to use a square pixels in straight rows but with adjacent rows staggered.

The spatial light modulator and more specifically the micromirror array is a relatively new optical device and new applications are being invented. Current applications are in adaptive optics, optical computing, optical image filtering and signal analysis, optical cross-switches in optical communications, metrology, displays and an array of imaging and printing applications. The current invention teaches how to create an accurate intensity-only image with a phase-modulating SLM. As such it could be used in many optical systems. For example in coherent image processing it can be used for image input, image multiplication, image convolution and autocorrelation, and for adaptive Fourier filtering. It can be used to even out a non-uniform illumination pattern or to create an desired illumination pattern, e.g., to increase signal to noise in optical metrology. It can be used to illuminate an object with structured light for 3D metrology or for entertainment displays. Everywhere a predictable intensity modulation that can be changed in a millisecond or less is needed a Micromirror according to the invention can be used.

The features discussed above can be combined in useful combinations. Some of the many useful combinations are set forth in the claims below.

While many of the preceding examples are cast in terms of a method, devices and systems employing this method are easily understood. A magnetic memory containing a program capable of instructing a device to practice the claimed method is one such device. A computer system having memory loaded with a program instructing a device to practice the claimed method is another such device.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A method of spatial intensity light modulation for use in optical projection systems comprising the steps of:
providing a regular grid of separately addressable mirror elements, said mirror element having a pivot action, wherein mirror elements in the grid are arranged so that a first mirror element has an adjacent second mirror element with a substantially different pivot action;
actuating the mirror elements to form a pattern; and
projecting radiation from the mirror elements onto an image plane to reproduce the pattern.

2. The method of claim 1, wherein said grid is a Cartesian grid.

3. The method of claim 1, wherein the mirror elements are deformed by application of an analog voltage.

4. The method of claim 1, wherein the grid has rows of pixels and the mirror elements in a row pivot in the same direction, and where mirror elements in adjacent rows pivot in opposite directions.

5. The method of claim 1, wherein the grid is composed of identical groups of four pixels, where each group has pixels pivoting in four different directions, and the vector sum over the directions in each group is zero.

6. The method of claim 1, wherein said grid is a hexagonal grid.

7. The method of claim 1, wherein the grid is composed of identical groups of mirror elements, wherein a group has mirror elements with four different pivot actions, and a vector sum of direction vectors for equally actuated mirror elements of the group is essentially zero.

8. The method of claim 1, wherein the mirror grid is formed on top of an integrated circuit.

9. The method of claim 1, wherein the projecting step includes the radiation passing through optics for Fourier filtering of the radiation after it is reflected light by the mirror elements of the grid.

10. The method of claim 1, wherein said method is used to print a pattern on a photosensitive layer.

11. The method of claim 10, wherein said photosensitive layer is a photoresist.

12. The method of claim 1, wherein said pattern is a microlithographic pattern containing lines narrower than 0.5 microns.

13. The method of claim 1, wherein said method is used to print a pattern on a heat-sensitive material.

14. The method of claim 1, wherein said method is used in optical computing.

15. The method of claim 1, wherein said method is used in two-dimensional signal processing.

16. The method of claim 1, wherein said method is used in a visual display.

17. A method of spatial intensity light modulation for use in optical projection systems comprising the steps of:
providing a regular grid of separately addressable mirror elements, said mirror element having a pivot action, wherein mirror elements in the grid are arranged so that a vector sum of direction vectors for a group of equally actuated adjacent mirror elements is essentially zero;
actuating the mirror elements to form a pattern; and
projecting radiation from the mirror elements onto an image plane to reproduce the pattern.

18. The method of claim 17, wherein said grid is a Cartesian grid.

19. The method of claim 17, wherein the mirror elements are deformed by application of an analog voltage.

20. The method of claim 17, wherein said group has the size two by two pixels.

21. The method of claim 17, wherein the grid has rows of pixels and the mirror elements in a row pivot in the same direction, and where mirror elements in adjacent rows pivot in opposite directions.

22. The method of claim 17, wherein the grid is composed of identical groups of four pixels, where each group has pixels tilting in four different directions, and the vector sum over the directions in each group is zero.

23. The method of claim 17, wherein said grid is a hexagonal grid.

24. The method of claim 17, wherein the grid is composed of identical groups of four pixels, where each group has pixels pivoting in four different directions, and the vector sum over the directions in each group is zero.

25. The method of claim 17, wherein the mirror grid is formed on top of an integrated circuit.

26. The method of claim 17, wherein the projecting step includes the radiation passing through optics for Fourier filtering of the radiation after it is reflected light by the mirror elements of the grid.

27. The method of claim 17, wherein said method is used to print a pattern on a photosensitive layer.

28. The method of claim 27, wherein said photosensitive layer is a photoresist.

29. The method of claim 17, wherein said pattern is a microlithographic pattern containing lines narrower than 0.5 microns.

30. The method of claim 17, wherein said method is used to print a pattern on a heat-sensitive material.

31. The method of claim 17, wherein said method is used in optical computing.

32. The method of claim 17, wherein said method is used in two-dimensional signal processing.

33. The method of claim 17, wherein said method is used in a visual display.

34. The method of claim 17, wherein said group includes three nearest neighbor mirror elements.

35. A method of spatial intensity light modulation for use in optical projection systems comprising the steps of:
providing a regular grid of separately addressable mirror elements, said mirror element having a pivot action, wherein mirror elements in the grid are arranged so that:
a first mirror element has an adjacent second mirror element with a substantially different pivot action; and
a vector sum of direction vectors for a group of equally actuated adjacent mirror elements is essentially zero;
actuating the mirror elements to form a pattern; and
projecting radiation from the mirror elements onto an image plane to reproduce the pattern.

36. The method of claim 35, wherein said grid is a Cartesian grid.

37. The method of claim 35, wherein the mirror elements are deformed by application of an analog voltage.

38. The method of claim 35, wherein said group has the size two by two pixels.

39. The method of claim 35, wherein the grid has rows of pixels and the mirror elements in a row pivot in the same direction, and where mirror elements in adjacent rows pivot in opposite directions.

40. The method of claim 35, wherein the grid is composed of identical groups of four pixels, where each group has pixels tilting in four different directions, and the vector sum over the directions in each group is zero.

41. The method of claim 35, wherein said grid is a hexagonal grid.

42. The method of claim 35, wherein the grid is composed of identical groups of four pixels, where each group has pixels pivoting in four different directions, and the vector sum over the directions in each group is zero.

43. The method of claim 35, wherein the mirror grid is formed on top of an integrated circuit.

44. The method of claim 35, wherein the projecting step includes the radiation passing through optics for Fourier filtering of the radiation after it is reflected light by the mirror elements of the grid.

45. The method of claim 35, wherein said method is used to print a pattern on a photosensitive layer.

46. The method of claim 45, wherein said photosensitive layer is a photoresist.

47. The method of claim 35, wherein said pattern is a microlithographic pattern containing lines narrower than 0.5 microns.

48. The method of claim 35, wherein said method is used to print a pattern on a heat-sensitive material.

49. The method of claim 35, wherein said method is used in optical computing.

50. The method of claim 35, wherein said method is used in two-dimensional signal processing.

51. The method of claim 35, wherein said method is used in a visual display.

52. The method of claim 35, wherein said group includes three nearest neighbor mirror elements.
